(19) United States
(12) Patent Application Publication
(10) Pub. No.: US 2022/0354310 A1
(43) Pub. Date: Nov. 10, 2022

(54) Utensil with Clamp Device

(71) Applicant: Isabelo R ONG III, New Westminster (CA)

(72) Inventor: Isabelo R ONG III, New Westminster (CA)

(21) Appl. No.: 17/736,985

(22) Filed: May 4, 2022

Related U.S. Application Data
(60) Provisional application No. 63/185,368, filed on May 7, 2021.

(51) Int. Cl. A47J 43/28

(52) U.S. Cl. CPC A47J 43/288; A47J 43/283

(57) ABSTRACT

The present device is that of a spatula with clamp lever and is intended for use in the handling, cooking, and serving of foods. The apparatus of the present device is comprised of a spatula and a clamp lever that can be configured either as a permanently attached clamp lever or a removable clamp lever for use only when clamping is desired. The clamp lever itself comprises a clamping blade and a trigger, and is constructed as a single Class-I type lever where the clamping blade and the trigger are positioned on opposite sides of the longitudinal axis of the spatula. The trigger, actuated by the index finger in a finger-squeezing like motion similar to that of a pistol trigger, rotates the clamp lever about its fulcrum resulting in the clamp blade to move towards the spatula blade.

### RELATED APPLICATIONS

This application claims the benefit of U.S. Provisional Application No. 63/185,368 filed on May 7, 2021, entitled “Utensil with Clamp Device”.

### FIELD OF THE INVENTION

The invention relates, in general, to tools and utensils used for the handling, preparing, cooking, and serving of foods.

### BACKGROUND OF THE INVENTION

Different utensils are used for different purposes. Common uses for utensils include, turning over food from one side to the other, positioning food on a cooking surface, and transferring food from one surface to another. Existing utensils used for these examples are often inadequate. Utensils with a flat blade, such as a turner spatula, typically used for turning over foods on a frying pan with hot oil, tend to splash hot oil when used for this purpose, potentially causing injury to the user. Clamping utensils, such as kitchen tongs, although eliminates the splashing of hot oil, have a tendency to damage food, especially those foods that are delicate such as fish, or eggs-over-easy. Utensils consisting of both a flat blade and a clamping mechanism are often difficult to use, have poor functionality, poor ergonomics, and have a limited range of use.

In view of the foregoing, the inventor has appreciated a need for a spatula with a clamping mechanism that is easy to use, has good functionality, good ergonomics, and good versatility.

### DESCRIPTION OF THE PRIOR ART

Various prior art culinary utensils and devices, and the like, as well as their apparatuses, exist. These patents or known prior uses disclose various types of culinary utensils and devices, but none of them, whether taken individually or in combination, disclose the specific details of the device in such a way as to bear upon the present device.
Lampron, U.S. Pat. No. 5,403,052 A (Egg Spatula)
Meyer, U.S. Pat. No. 2,573,922 (Automatic Gripping Spatula)
Floyd et al., U.S. Pat. No. 9,254,065 B2 (Wonder Spatula)
Gibson et al., U.S. Pat. No. 2015/0305570 A1 (Flipper Tong Assembly)
China Pat. No., CN210748901U (Spatula Capable of Clamping)

In reference to the aforementioned patents, the design and construction of the devices can be characterized as a combination of two Class-III levers with a shared fulcrum. These resemble your standard kitchen tongs in construction.

The issue with this design and construction is the difficulty in sliding the spatula blade under the food. In order to most effectively slide the spatula blade under food, its front edge should remain flat against the surface as the spatula is slid towards the food. This minimizes the occurrence the front edge of the spatula blade snagging and damaging the food, as most concerning with delicate stuck-on foods, ex) eggs-over-easy on a worn-out frying pan.

The most effective way to ensure the front edge of the spatula blade remains flat against the surface is by imparting a downward force (towards surface) on it; and the most trivial, ergonomic, and practical way to achieve this is by applying a downward force on the handle with the thumb (or ball of the thumb) of your grasping hand. In case of the aforementioned patents however, the handle is the resistance arm of the clamping mechanism, and applying a downward force on it puts said devices in closed position instead of imparting a downward force on the spatula blade, thus rendering the said devices inadequate.
Rader, U.S. Pat. No. 4,002,365 A (Food Handling Tongs)
Kozlinski, U.S. Pat. No. 4,904,009 A (Food Handling Tongs)

In reference to the aforementioned patents, the design and construction of the devices can be characterized as a combination of two Class-I levers with a shared fulcrum. These resemble your standard scissors in construction.

Due to the standard scissor design mechanics inherent in said devices, imparting a downward force on the front edge of the spatula blade is awkward, uncomfortable, and non-ergonomic. To do so, the user would have to lock their grasping hand in an open position to ensure the utensil remains in open position, while generating a downward force on the effort arm (handle) of the clamping mechanism via the dorsal side of the fingers used, usually the index, middle, ring, and pinky fingers.
Raymond, U.S. Pat. No. 2,357,764 A (Culinary Implement)
Collins, U.S. Pat. No. 856,446 A (Culinary Utensil)
Di Paolo, U.S. Pat. No. 2006/0202494 A1 (Combination Spatula and Tong Device for Handling Food)

In reference to the aforementioned patents, the design and construction of the devices can be characterized as a standard turner spatula with a Class-I lever clamping mechanism, whereby the resistance arm and effort arm are on the same side of the utensil, i.e., resistance arm and effort arm are both situated on the front side of the utensil. The issue with this design and construction is its propensity to damage food. Due to the spring-loaded normally closed position of the clamping mechanism, the clamping force produced is predetermined and permanent. This is problematic for delicate foods such as eggs. Throttling the clamping mechanism open is impractical and not easy for use, thus rendering it inadequate.
Fout U.S. Pat. No. 4,753,472 A (Baker's Peel)
Thomas, U.S. Pat. No. 2,643,907 A (Culinary Utensil)
Brown, U.S. Pat. No. 1,386,311 A (Culinary Utensil)
Binkert, U.S. Pat. No. 3,761,120 A (Food Patty Turning Device)

In reference to the aforementioned patents, the design and construction of the devices utilize a system of mechanical linkages instead of a solitary lever design to achieve clamping. The drawback of utilizing a system of mechanical linkages instead of a solitary lever design is the relative complexity and difficulty of construction and assembly, as well as a decrease in reliability. As the number of moving parts increase so do the possible points of failure.

### SUMMARY OF THE INVENTION

The present device is a spatula with clamp lever that seeks to provide a practical, easy-to-use, effective, versatile, reliable, and ergonomic way of handling, preparing, cooking, and serving of foods—most commonly for, but not limited to, turning over food from one side to the other. Existing utensils used for this example are often inadequate.

Briefly described, the apparatus of the present device is comprised of a spatula and a clamp lever. The spatula itself is comprised of a spatula blade, a first shaft, and a handle. The clamp lever itself, constructed as a single Class-I type lever, comprises a clamp blade, a second shaft, and a trigger. The clamp lever is actuated by the index finger via the trigger in a finger-squeezing motion similar to that required for a pistol trigger. The clamp lever can be configured as permanently attached to the spatula or as a removable attachment.

The present device also seeks to provide a versatile utensil that can be used in scenarios not limited to clamping purposes only. When configured as a removable attachment, the clamp lever may attach to any spatula able to accommodate it for proper and effective use. Configuring the clamp lever as a removable attachment broadens the use and applications of the present device by allowing it to be used in the same manner as a standard turner spatula when the clamp lever is not attached.

In accordance with an aspect of the invention there is provided a kitchen utensil comprising: a spatula having a spatula blade and handle connected by a first shaft; and a clamp lever having a clamp blade and trigger connected by a second shaft. The clamp lever is rotatably connected to the spatula in a Class-I lever arrangement; the clamp blade and trigger are positioned on opposite sides of the longitudinal axis of the first shaft, and the clamp blade is positioned opposing the spatula blade, and trigger is positioned opposing part of the handle.

The trigger may be located and sized to be actuated by an index finger of a user when holding the handle. The trigger may not extend a full length of the handle portion. The trigger may not interfere with any of the fingers grasping the handle during normal operation.

The clamp lever and spatula may be rotatable about a fulcrum located along their shaft portions. The clamp lever may be removably connected to the spatula.

The utensil may comprise a bias member for biasing the clamp blade away from the spatula blade. The utensil may comprise a lock for holding the clamp blade against the spatula blade in a clamped position.

### BRIEF DESCRIPTION OF THE DRAWINGS

Various objects, features and advantages of the invention will be apparent from the following description of embodiments of the invention, as illustrated in the accompanying drawings. The drawings are not necessarily to scale, emphasis instead being placed upon illustrating the principles of various embodiments of the invention.

FIG. 1A is a perspective view of an embodiment of the spatula with clamp lever, configured as a spatula with permanently attached clamp lever, in open and clamped position, of the present device.

FIG. 1B is an exploded view of the spatula with clamp lever, shown without spring and pin, configured as a spatula with permanently attached clamp lever of FIG. 1A.

FIG. 10 is an exploded view of the spatula with clamp lever, configured as a spatula with permanently attached clamp lever of FIG. 1A.

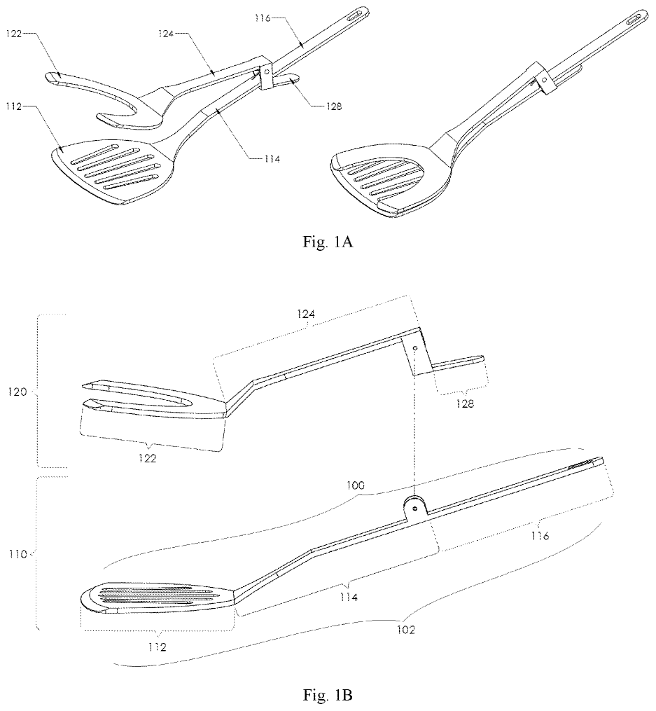

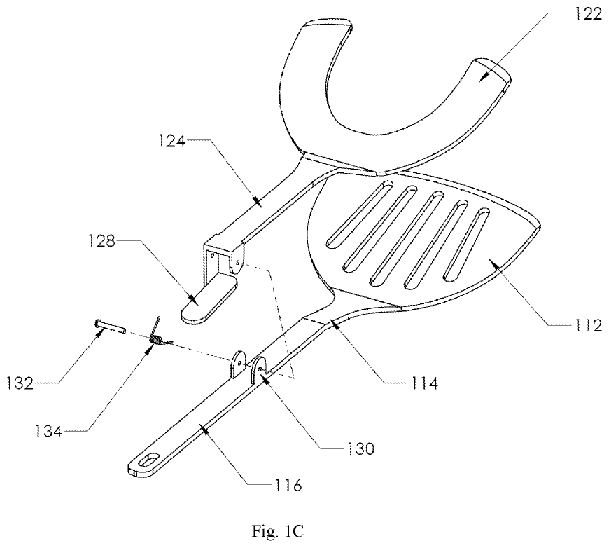

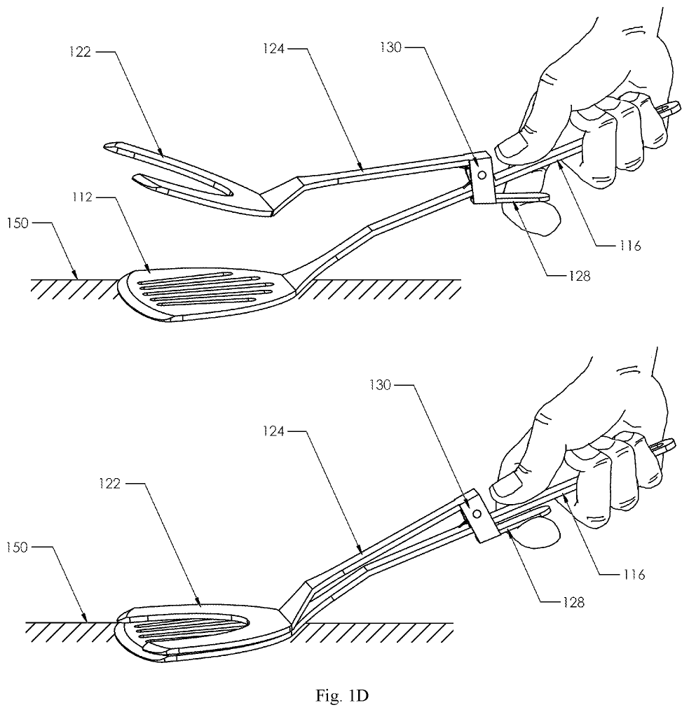

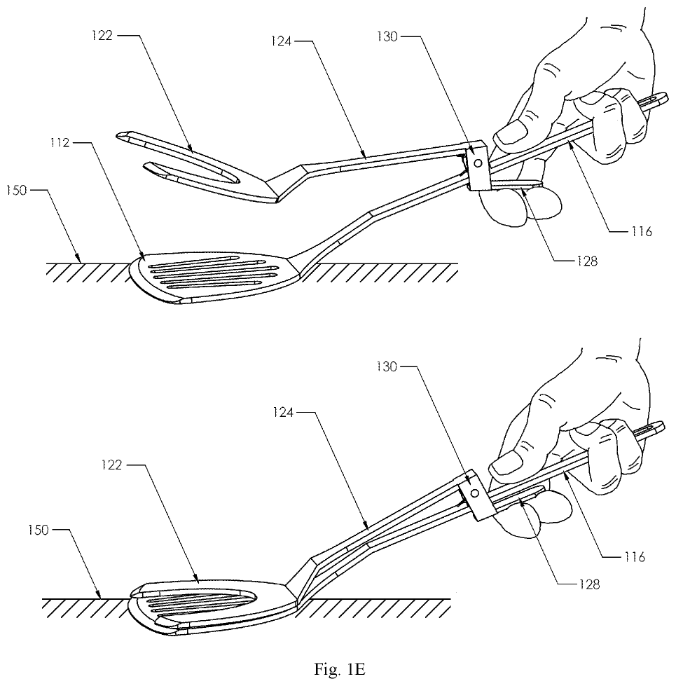

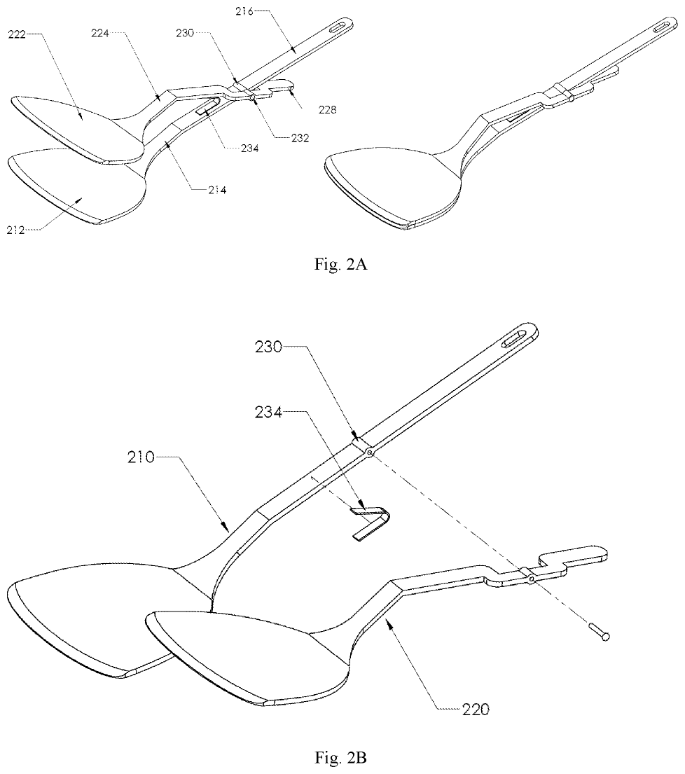

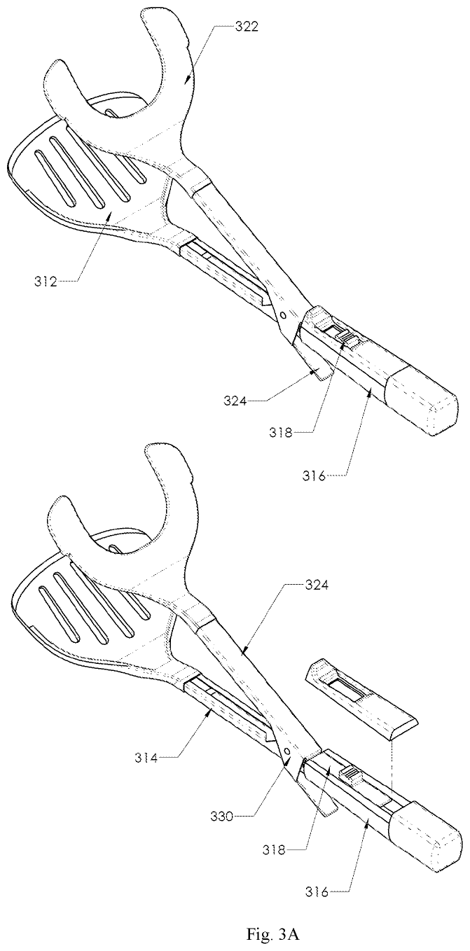

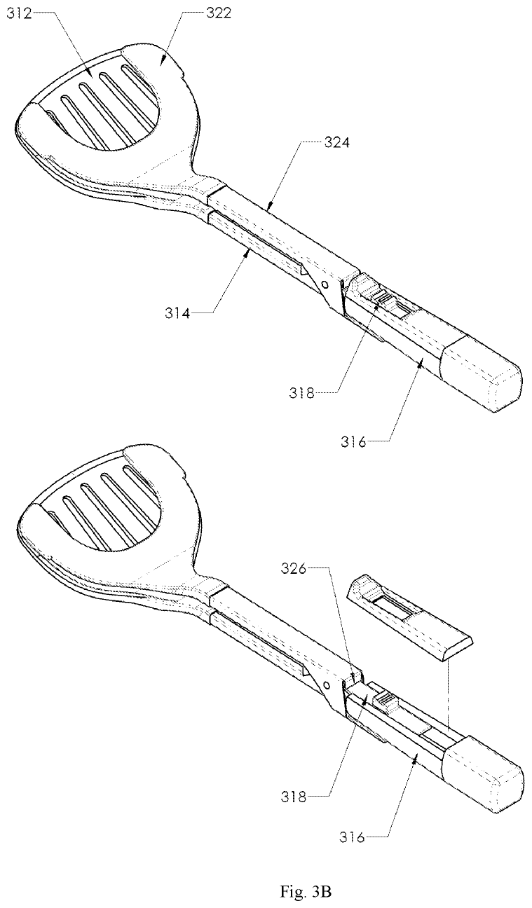

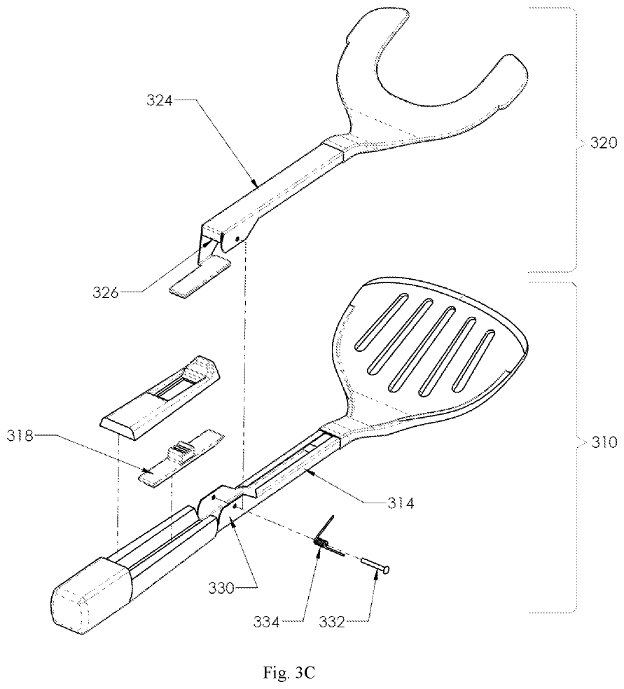

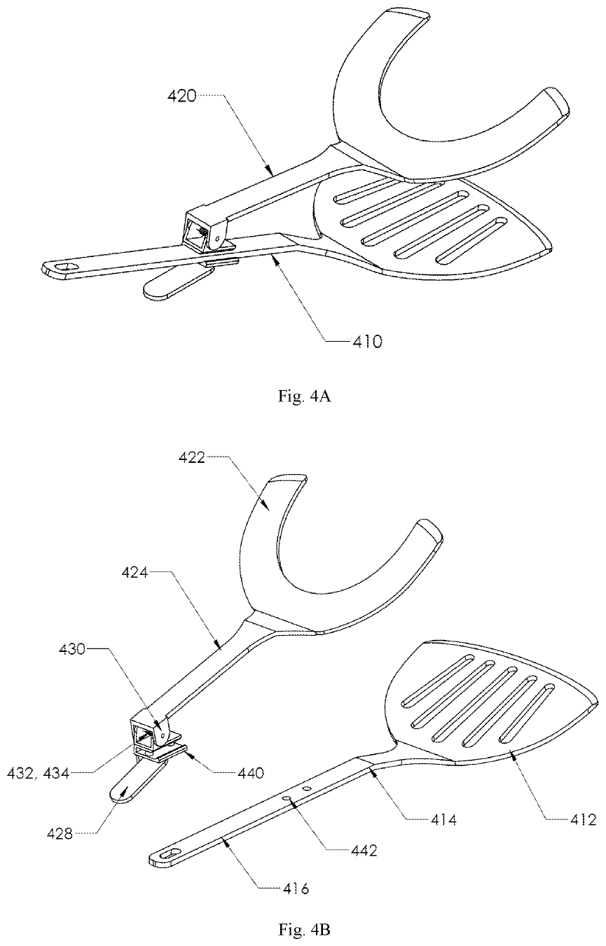

FIG. 1D is a view of the spatula with clamp lever, configured as a spatula with permanently attached clamp lever, in operation using index finger on the trigger, of FIG. 1A.

FIG. 1E is a view of the spatula with clamp lever, configured as a spatula with permanently attached clamp lever, in operation using index and middle fingers on the trigger, of FIG. 1A.

FIG. 2A is a perspective view of an embodiment of the spatula with clamp lever, configured as a spatula with permanently attached clamp lever, in open and clamped position, of the present device.

FIG. 2B is an exploded view of the spatula with clamp lever, configured as a spatula with permanently attached clamp lever of FIG. 2A.

FIG. 3A is a perspective view of an embodiment of the spatula with clamp lever, configured as a spatula with permanently attached clamp lever, depicted in unlocked position, of the present device.

FIG. 3B is a perspective view of an embodiment of the spatula with clamp lever, configured as a spatula with permanently attached clamp lever, depicted in locked position, of FIG. 3A.

FIG. 3C is an exploded view of the spatula with clamp lever, configured as a spatula with permanently attached clamp lever of FIG. 3A.

FIG. 4A is a perspective view of the spatula with clamp lever, configured as a spatula with removable clamp lever, depicted in its attached form, of the present device.

FIG. 4B is a perspective view of the spatula with clamp lever, configured as a spatula with removable clamp lever, depicted in its detached form, of FIG. 4A.

FIG. 4C is an exploded view of the removable clamp lever only of FIG. 4A.

FIG. 5A is an exploded view of an embodiment of the spatula with clamp lever, configured as a spatula with removable clamp lever, of the present device.

FIG. 6A is an exploded view of an embodiment of the spatula with clamp lever, configured as a spatula with removable clamp lever, of the present device.

FIG. 7A is several embodiments of the spatula blade and clamp blade of the spatula with clamp lever, of the present device.

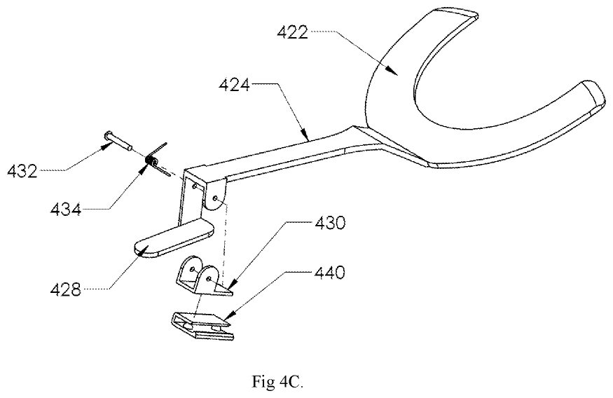

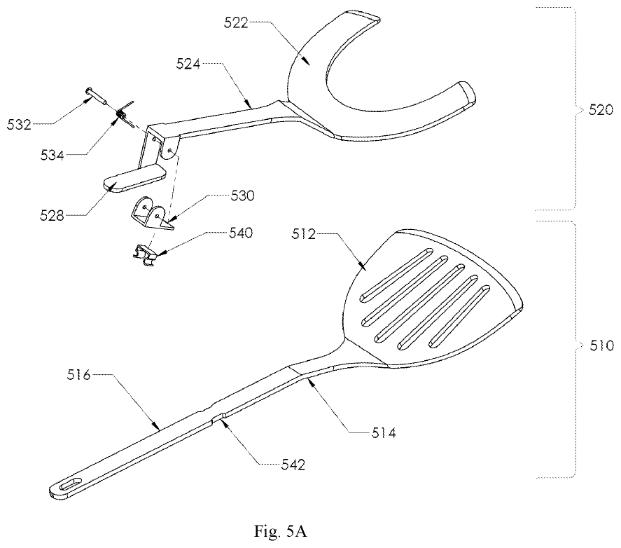

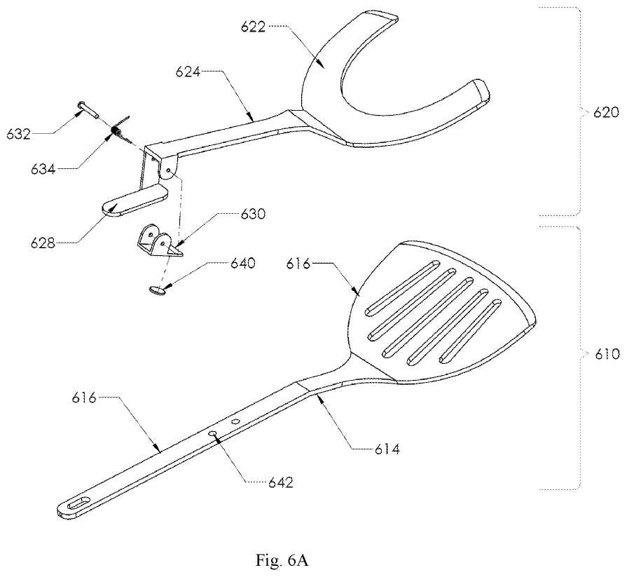

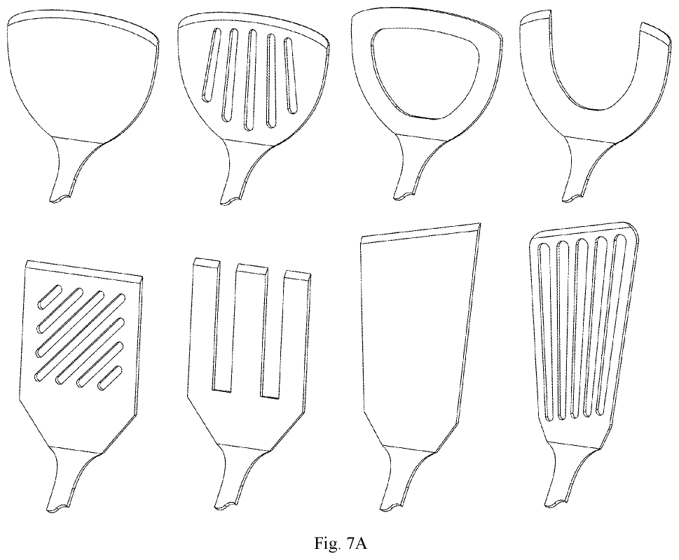

For terminology reference FIGS. 1A, 1B, and 10. Front side 100, reverse side 102, spatula 110, spatula blade 112, first shaft 114, handle 116, clamp lever 120, clamp blade 122, second shaft 124, trigger 128, fulcrum 130, pin 132, spring 134.

### DETAILED DESCRIPTION OF THE INVENTION

With reference to the accompanying figures, a kitchen utensil is described, comprised of a spatula and a clamp lever. The spatula itself is comprised of a spatula blade, a first shaft, a handle, and in some embodiments, a lock. The clamp lever itself is comprised of a clamp blade, a second shaft, a trigger, a fulcrum, a spring, a pin, and in some embodiments, a mounting adaptor. The clamp lever is constructed as a single Class-I type lever, with the fulcrum situated along the length of the first shaft, and the resistance arm and the effort arm of the lever are positioned on opposite sides of the longitudinal axis of the first shaft. That is, the resistance arm of the lever is positioned on the front side (or top) of the spatula, and the effort arm of the lever is positioned on the reverse side (or bottom) of the spatula. The clamp blade is connected to one end of the second shaft, and is positioned on the front side of the spatula, opposing the spatula blade. The trigger is connected to the other end of the second shaft and is positioned on the reverse side of the spatula, opposing a portion of the handle. The clamp blade and trigger are positioned on opposite sides of the longitudinal axis of the first shaft. The trigger does not extend the full length of the handle. It is limited in length, so it does not interfere with any fingers grasping the handle during normal operation by a person of average size and ordinary skill. Preferred embodiments of the trigger may be further described structurally by one or more of: being shorter than the handle by at least 7 cm, overlapping the handle by less than 5 cm, the difference between handle length and portion of trigger overlapping the handle is more than 6 cm.

The Class-I type lever design of the clamp lever of the present device enables the user to grasp the handle in a secure manner while being able to actuate the clamp lever in an ergonomic, easy-to-use motion. The clamp lever is actuated by the index finger in a finger-squeezing motion similar to that required for a pistol trigger. The trigger design provides a familiar, ergonomic motion, free of any over-exertion of the hand or fingers. It also enables the user to maintain secure grasp of the handle with the remaining non-trigger actuating fingers. The thumb, positioned on the front side of the handle also serves the purpose of providing the much necessary downward force required for effective operation. Just as any standard turner spatula would require, the present device is most effective when the front edge of the spatula blade remains flat against the surface as it is slid towards the food. This is so the front edge of the spatula blade does not snag and damage the food as it is slid towards it. In order to force the front edge of the spatula blade flat against the surface a downward force should be generated; and the most ergonomic way to achieve this is via the thumb pushing downward on the handle.

FIGS. 1A, 1B, 10, 1D, and 1E, shows various views of the spatula with clamp lever configured as a spatula with permanently attached clamp lever, of the present device. The spatula with clamp lever is comprised of a spatula 110 and clamp lever 120. The spatula 110 itself is comprised of a spatula blade 112, a first shaft 114, and a handle 116. The clamp lever 120 itself is comprised of a clamp blade 122, a second shaft 124, a trigger 128, a fulcrum 130, a pin 132, and a spring 134. In this configuration, the fulcrum 130 is permanently affixed to the first shaft 114. The clamp lever 120 is attached to the fulcrum 130 via pin 132. The clamp lever 120 is a Class-I type lever where the resistance arm and effort arm of the lever are positioned on opposite sides of the longitudinal axis of the first shaft 114. That is, the resistance arm of the lever is positioned on the front side 100 of the spatula 110, and the effort arm of the lever is positioned on the reverse side 102 of the spatula 110. The clamp blade 122 is connected to one end of the second shaft 124, and is positioned on the front side 100 of the spatula 110, opposing the spatula blade 112. The clamp blade 122 is the member that physically secures food against the spatula blade 112 when engaged. The trigger 128 is connected to the other end of the second shaft 124, and is positioned on the reverse side 102 of the spatula 110, opposing a portion of the handle 116. The clamp blade 122 and trigger 128 are positioned on opposite sides of the longitudinal axis of the first shaft 114. The trigger 128 does not extend the full length of the handle 116. It is limited in length so it does not interfere with any fingers grasping the handle 116 during normal operation by a person of average size and ordinary skill, as depicted in FIGS. 1D and 1E. The trigger 128 is actuated by the index finger in a finger-squeezing motion similar to that required for a pistol trigger. Although the preferred method of actuation is with the index finger only, as depicted in FIG. 1C, users with smaller than average size hands may find it more ergonomic to use both index and middle fingers, as depicted in FIG. 1E. Clamping force is achieved via Class-I lever mechanics; as the trigger 128 is actuated, the clamp lever 120 pivots on the fulcrum 130 causing the clamp blade 122 to move towards the spatula blade 112. The spring 134, configured in this embodiment as a torsion spring, provides a return feature whereby the clamp lever 120 returns to its normally open position when the trigger 128 is released or is not actuated.

The present device provides a practical, easy-to-use, effective, and ergonomic way of clamping foods—most commonly for, turning over food from one side to the other. Just as any standard turner spatula would require, the present device is most effective when the front edge of the spatula blade 112 remains flat against the surface 150 as it is slid towards the food. This is so the front edge of the spatula blade 112 does not snag and damage the food as it is slid towards it. In order to force the front edge of the spatula blade 112 flat against the surface 150 a downward force should be generated; and the most ergonomic way to achieve this by using the thumb to push downward against the handle 116. This is possible because the trigger 128 is actuated by the index finger, thus relieving the thumb of this task and allowing it to focus on generating a downward force on the handle 116. As well, the thumb, along with the remaining non-trigger actuating fingers can maintain a constant grasp on the handle 116 during operation without any need for repositioning of the grasping hand, allowing the user to maintain optimal control of the present device. To ensure these benefits are realized, the physical size of the trigger 128 is limited in length so it does not interfere with any fingers grasping the handle 116 during normal operation by a person of average size and ordinary skill, as depicted in FIGS. 1D and 1E. The trigger 128 should remain as a trigger and not become a handle. That is, the trigger 128 should not be large (long) enough to effectively accommodate actuation by the index, middle, ring, and pinky fingers at the same time. Thus, preferred embodiments of the trigger may be further described structurally by one or more of: being shorter than the handle 116 by at least 7 cm, overlapping the handle 116 by less than 5 cm, difference between handle 116 length and portion of trigger 128 overlapping the handle 116 is more than 6 cm. Having a trigger 128 large (long) enough in size to effectively accommodate actuation by the index, middle, ring, and pinky fingers at the same time would significantly alter the mechanics and operation of the present device, changing its actuation from a ‘pistol trigger’ like motion to a hand squeezing motion similar to that required for standard pliers. This change in mechanics and operation would negate the advantages provided by the present device. These advantages and described mechanics of operation apply to all embodiments and configurations.

FIGS. 2A and 2B shows various views of another embodiment of the spatula with clamp lever configured as a spatula with permanently attached clamp lever, of the present device. In this configuration, the fulcrum 230 is permanently affixed to, and is coincident with the first shaft 214. The spring 234 utilized in this configuration is a leaf spring instead of a torsion spring.

FIG. 3A, 3B, 3C shows various views of another embodiment of the spatula with clamp lever configured as a spatula with permanently attached clamp lever, of the present device. The spatula with clamp lever is comprised of a spatula 310 and a clamp lever 320. The spatula 310 itself is comprised of a spatula blade 312, a first shaft 314, a handle 316, and a lock 318. The clamp lever 320 itself is comprised of a clamp blade 322, a second shaft 324, a trigger 324, a fulcrum 330, a pin 332, and a spring 334, configured in this embodiment as a torsion spring, but not limited to. The clamp lever 320 is a Class-I type lever where the resistance arm and effort arm of the lever are positioned on opposite sides of the longitudinal axis of the first shaft 314. That is, the resistance arm of the lever is positioned on the front side of the spatula 310, and the effort arm of the lever is positioned on the reverse side of the spatula 310. The lock 318 is configured as a manually actuated mechanical sliding member that is housed within the handle 316. In its unlocked position, the lock 318 is fully retracted within the handle 316, as depicted in FIG. 3A. There is no portion of the lock 318 that protrudes outside the handle 316 in the unlocked position. In the locked position, the lock 318 does protrude outside the handle 316, as depicted in FIG. 3B. This protruding portion of the lock 318 contacts the proximal-end-of-the-second-shaft 326 constraining rotation of the clamp lever 320, thus keeping the clamp lever 320 in clamped (closed) position, as depicted in FIG. 3B. The lock 318 can only be slid to its locked position when clamp lever 320 is in clamped position.

FIGS. 4A, 4B, and 4C, shows various views of another embodiment of the spatula with clamp lever configured as a spatula with removable clamp lever, of the present device. The spatula with clamp lever is comprised of a spatula 410 and a removable clamp lever 420. The spatula 410 itself is comprised of a spatula blade 412, a first shaft 414, and a handle 416. The removable clamp lever 420 itself, configured to be a removable attachment in this configuration, is comprised of a clamp blade 422, a second shaft 424, a trigger 428, a fulcrum 430, a pin 432, a spring 434, and a mounting adaptor 440. In this embodiment, the fulcrum 430 is not permanently affixed to the first shaft 114. The fulcrum 430 is connected to the second shaft 424 via pin 432. A mounting adaptor 440, configured in this embodiment as a side-mount clip, is permanently affixed to the underside of the fulcrum 430. The mounting adaptor 440 facilitates attachment of the removable clamp lever 420 to the spatula 410. The removable clamp lever 420 is designed to be a removable attachment used when clamping is desired but kept detached otherwise. The first shaft 414 comprises an alignment feature 442 to better facilitate attachment of the removable clamp lever 420 to the spatula 410. The alignment feature 442, configured as alignment holes in this embodiment, mates with the mounting adaptor 440 when removable clamp lever 420 is attached to the spatula 410. The mounting adaptor 440, configured in this embodiment as a side-mount clip, incorporates features, configured in this embodiment as dimples, but not limited to, designed to concentrically mate with the alignment feature 442, restraining the removable clamp lever 420 laterally and axially to the first shaft 414. The removable clamp lever 420 may attach to any utensil able to accommodate it for proper and effective use. Configuring the removable clamp lever 420 as a removable attachment broadens the use and applications of the present device by allowing it to be used in the same manner as a standard turner spatula when removable clamp lever 420 is not attached.

FIG. 5A, shows an exploded view of another embodiment of the spatula 510 and removable clamp lever 520, of the present device. In this embodiment the mounting adaptor 540 is configured to be a front-mount clip. The mounting adaptor 540 is designed to mate with the alignment feature 542, configured in this embodiment to be alignment notches, on the first shaft 514, restraining the removable clamp lever 520 laterally and axially to the first shaft 514.

FIG. 6A, shows an exploded view of another embodiment of the spatula 610 and removable clamp lever 620, of the present device. In this embodiment the mounting adaptor 640 is configured to be a magnet. The fulcrum 630, configured in this embodiment to incorporate features (dimples) on its underside, is designed to concentrically mate with the alignment feature 642, configured in this embodiment to be alignment holes, on the first shaft 614, restraining the removable clamp lever 620 laterally and axially to the first shaft 614. In this embodiment, the first shaft 614 will need to be constructed of steel.

FIG. 7A, shows various embodiments of the spatula blade and clamp blade, of the present device. Although the preferred embodiment of the clamp blade is a U-shaped member, it is not limited to that shape. The embodiments depicted are several examples of shapes either the spatula blade or clamp blade can assume.

The present device, including all embodiments, configurations, and components, can be constructed with metal, wood, polymer, or any combination thereof, unless otherwise stated.

While the foregoing written description of the present device enables one of ordinary skill to make and use what is considered presently to be the best mode thereof, those of ordinary skill will understand and appreciate the existence of variations, combinations, and equivalents of the specific embodiments, methods, and examples herein.

Terms such as “top”, “bottom”, “distal”, “proximate”, “below,” “above,” “upper, are used herein for simplicity in describing relative positioning of elements of the conduit or device, as depicted in the drawings or with reference to the surface datum. Although the present invention has been described and illustrated with respect to preferred embodiments and preferred uses thereof, it is not to be so limited since modifications and changes can be made therein which are within the full, intended scope of the invention as understood by those skilled in the art.

1. A kitchen utensil comprising:
a spatula having a spatula blade and handle connected by a first shaft; and
a clamp lever having a clamp blade and trigger connected by a second shaft,
wherein the clamp lever is rotatably connected to the spatula in a Class-I lever arrangement,
whereby the clamp blade and trigger are positioned on opposite sides of the longitudinal axis of the first shaft, and
whereby the clamp blade is positioned opposing the spatula blade, and trigger is positioned opposing part of the handle.

2. The utensil of claim 1, wherein the trigger is located and sized to be actuated by an index finger of a user when holding the handle.

3. The utensil of claim 1, wherein the trigger does not extend a full length of the handle portion.

4. The utensil of claim 1, wherein the trigger does not interfere with any of the fingers grasping the handle during normal operation.

5. The utensil of claim 1, wherein the clamp lever and spatula are rotatable about a fulcrum located along their shaft portions.

6. The utensil of claim 1, further comprising a bias member for biasing the clamp blade away from the spatula blade.

7. The utensil of claim 1, further comprising a lock for holding the clamp blade against the spatula blade in a clamped position.

8. The utensil of claim 1, wherein the clamp lever is removably connected to the spatula.
